(19) United States
(12) Patent Application Publication
(10) Pub. No.: US 2022/0308182 A1
(43) Pub. Date: Sep. 29, 2022

(54) CUMULATIVE SHORT PULSE EMISSION FOR PULSED LIDAR DEVICES INCLUDING A LONG EXPOSURE TIME

(71) Applicant: Robert Bosch GmbH, Stuttgart (DE)

(72) Inventors: Mustafa Kamil, Ludwigsburg (DE); Nico Heussner, Karisruhe (DE)

(21) Appl. No.: 17/594,849

(22) PCT Filed: May 4, 2020
(86) PCT No.: PCT/EP2020/062236

§ 371 Date: Dec. 10, 2021

(30) Foreign Application Priority Data
May 3, 2019 (DE) 10 2019 206 318.7

(51) Int. Cl. G01S 7/481; G01S 7/487; G01S 17/89

(52) U.S. Cl. CPC G01S 7/4817; G01S 7/4873; G01S 17/89

(57) ABSTRACT

A method for operating a LIDAR device using a control unit. At least one radiation source is activated to generate pulsed beams and the pulsed beams are emitted into a scanning area. The beams that are reflected or backscattered in the scanning area are received by a receiving optical system and guided onto a detector. An amplitude profile of a reference pulse is emulated by the pulsed beams of the at least one radiation source. It is possible to generate and emit multiple pulsed beams temporally quickly one after the other. The pulsed beams have an increasingly ascending and subsequently once again descending amplitude as a function of time. The pulsed beams have a pulse duration, which is shorter than a pulse duration of the reference pulse. The pulsed beams are temporally spaced apart from one another by breaks.

### FIELD

The present invention relates to a method for operating a LIDAR device with the aid of a control unit, at least one radiation source being activated by the control unit for the purpose of generating pulsed beams and the pulsed beams being emitted into a scanning area, the beams that are reflected or backscattered in the scanning area being received by a receiving optical system and guided onto a detector. Furthermore, the present invention relates to a control unit, a LIDAR device, a computer program as well as a machine-readable memory medium.

### BACKGROUND INFORMATION

Some LIDAR devices in the related art generate pulsed beams having a minimal pulse energy and pulse duration in order to not adversely affect eye safety.

Short pulse durations are advantageous when the flight time of an emitted pulse is ascertained based on a threshold value detection. A threshold value detection of this type may be made possible with the aid of APD-based detectors or SPAD detectors. Via high pulse frequency it is possible to detect a flight time based on individual photon detection, while at the same time having minor likelihood for maloperation as a result of a smaller number of background photons in the active exposure widow.

In detectors, in which photons are converted into charge carriers over longer time units with the aid of the photoelectric effect, accumulated and read out as such, as measurable voltage after the end of the exposure, pulses including a longer pulse duration are necessary in order to enable an optimal signal-to-noise ratio. Detectors of this type are usually based on CCD or CMOS technologies. In order to optimally expose these detectors, radiation sources and appropriate drivers having more power must be used.

### SUMMARY

An object of the present invention is to provide a method for operating a LIDAR device including an imaging detector, in the case of which different radiation sources and drivers of the radiation sources may be used.

This object may be achieved with the aid of example embodiments of the present invention. Advantageous embodiments of the present invention disclosed herein.

According to one aspect of the present invention, a method for operating a LIDAR device with the aid of a control unit is provided. In accordance with an example embodiment of the present invention, in one step, at least one radiation source is activated by the control unit for the purpose of generating pulsed beams. The pulsed beams generated by the at least one radiation source are emitted into a scanning area. The beams that are reflected and/or backscattered in the scanning area are received by a receiving optical system and guided onto a detector. The detector may preferably be designed as a so-called imager that is based on a CCD technology or a CMOS technology. The radiation source, which is driven by the control unit, is used to emulate an amplitude profile of a reference pulse via the pulsed beams of the at least one radiation source. The reference pulse may preferably have a pulse width or a pulse duration that is necessary to optimally expose the detector.

According to a further aspect of the present invention, a control unit is provided, the control unit being configured to carry out the method according to the present invention.

According to one aspect of the present invention, a computer program is moreover provided including instructions that prompt a control unit to carry out the method when the computer program is carried out by the control unit. According to a further aspect of the present invention, a machine-readable memory medium is provided, on which the computer program is stored.

According to a further aspect of the present invention, a LIDAR device for scanning a scanning area with the aid of pulsed beams is provided. In accordance with an example embodiment of the present invention, the LIDAR device includes at least one radiation source that is operable by a control unit. The LIDAR device furthermore includes a receiving optical system for receiving and forwarding the beams that are reflected and/or backscattered in the scanning area onto at least one detector. The at least one radiation source is operable by the control unit in such a way that multiple pulsed beams emulate a wider reference pulse in an amplitude-modulated manner.

In this way, many short pulsed beams that are emitted temporally closely one after the other in the sense of a “burst” operation are generated. The pulsed beams may be folded and modulated with the aid of a low-frequency pulse time function corresponding to an envelope curve or a reference pulse. The reference pulse describes the course of a long, highly energetic pulse and includes many short pulsed beams as a result of the method.

With the aid of the method, a single reference pulse generated by a powerful radiation source may in particular be emulated by a plurality of short less powerful pulses that are generated temporally quickly one after the other and adjusted in their amplitude according to the reference pulse.

The reference pulse that is cumulatively emulated by the pulsed beams enables a time-of-flight measurement via threshold value detection and a high signal-to-noise ratio in the case of long exposure times of the detector.

With the aid of the method in accordance with the present invention, radiation sources, such as for example lasers or LEDs, may be used that have less power as compared to radiation sources that would have to generate a beam corresponding to the reference pulse. In this way, a high flexibility may be implemented when selecting the radiation source and the corresponding drivers for activating the radiation source, since powerful and cost-intensive radiation sources may be replaced by fast and less powerful radiation sources.

Moreover, the method in accordance with the present invention may enable a higher flexibility in the pulse energy distribution over its duration and thus offer new freedoms when configuring eye safety.

According to one exemplary embodiment of the present invention, the pulsed beams are generated by the at least one radiation source in an amplitude-modulated manner. The at least one radiation source may be triggered by the control unit in a targeted manner and modulated in its intensity or power. With the aid of such a targeted generation of the pulsed beams and an amplitude modulation of the pulsed beams, a reference pulse may be optimally emulated. The reference pulse is preferably designed as a desired relatively long pulse that is advantageous for optimal exposure of the detector.

According to a further exemplary embodiment of the present invention, an envelope curve modulation of the beams generated in a pulsed manner is carried out using the reference pulse as the envelope curve. The beams generated in a pulsed manner may be adapted to the amplitude profile of the envelope curve and emulate the reference pulse particularly precisely.

The particular pulsed beams may have a maximal amplitude, in particular, which corresponds or follows an amplitude profile of the envelope curve.

The amplitude of the beams generated in a pulsed manner may thus follow a wider Gaussian curve. In particular, every generated beam may have an increasing maximal amplitude that increasingly drops at a vertex or maximal point.

According to a further specific embodiment of the present invention, the pulsed beams are generated by the at least one radiation source to have the same pulse width. An emulation of the reference pulse of this type may be carried out technically particularly easily since a temporal modulation may be dispensed with.

According to a further specific embodiment of the present invention, the pulsed beams are generated by the at least one radiation source in a temporally modulated manner. In this way, the emulation of the reference pulse may be further improved in that the pulse durations of the particular short pulses are variably adjusted. In particular, the particular pulse durations of the generated beams may be adjusted and modified independently of one another.

A dynamic pulse duration adjustment may also be carried out. The pulse duration of the particular beams may be for example reduced or increased depending on the situation, the radiation power emitted into the scanning area possibly being varied as a result thereof. This adjustment possibility may be used to increase eye safety, for example.

According to a further specific embodiment of the present invention, the pulsed beams are generated by the at least one radiation source in a sectionally overlapping manner, for example. As a result of a targeted pulse overlap, it is possible to implement an improved emulation of the reference pulse. In this way, the pulsed beams may be generated at a temporally closer distance with regard to one another or more quickly after one another and thus emulate the reference pulse more precisely.

According to a further exemplary embodiment of the present invention, an overlap of the pulsed beams is implemented by activating at least two radiation sources in an offset manner and/or by reactivating the at least one radiation source, while generating a pulsed beam. An offset of the generated beams may result for example from the use of multiple radiation sources. In this case, the control unit is able to activate several radiation sources and coordinate them temporally.

Furthermore, the at least one radiation source may be operated by the control unit in such a way that the radiation source is reactivated to generate pulsed beams even before the power “zero” is reached. At the end of the long pulse time function or of the reference pulse, power cannot be emitted until the next long pulse. A so-called “time-of-flight” method including breaks may thus be carried out by the LIDAR device between the reference pulses.

According to a further exemplary embodiment of the present invention, the pulsed beams are generated by the at least one radiation source at a variable temporal distance to one another. In addition to the flexibility in choosing the radiation source and the driver or the control unit while being less dependent on the selected detection principle, a control of the temporal energy density of the long pulse over time may be reached by adjusting “energy gaps” or the areas between the reference curve and the short pulsed beams. In the case of a constant, long pulse, a limitation would be involved. In addition, limitations of the pulse energy that result for a single emitter are overcome in that the energies of different emitters or radiation sources are added to one pulse.

According to a further exemplary embodiment of the present invention, the temporal distances for setting a signal-to-noise ratio are adaptively set. In this way, the ratio between energy gaps and the generated radiation power may be adaptively set to allow for maximal eye safety. For example, a given or a measured background light is ascertained and used to adjust the energy gaps and/or the generated radiation power. As soon as the signal-to-noise ratio exceeds a predefined threshold value, more or larger energy gaps or distances between the pulsed beams may be admitted.

According to a further specific embodiment of the present invention, the pulsed beams are generated by the at least one radiation source in a wavelength-modulated manner. In addition to the overlap of individual pulses or pulsed beams, a wavelength of the pulsed beams may be set. A wavelength modulation of this type may be in particular used for noise suppression. In the case of the wavelength modulation, the wavelength of the individual pulsed beams may be varied during the emulation of the reference pulse.

In the following, preferred exemplary embodiments of the present invention are elucidated in greater detail with reference to the highly simplified schematic illustrations.

### BRIEF DESCRIPTION OF THE DRAWINGS

FIG. 1 shows a schematic illustration of a LIDAR device according to one specific embodiment of the present invention.

FIG. 2 shows a schematic diagram for the purpose of illustrating pulsed beams that were generated with the aid of a method according to one specific embodiment of the present invention.

FIG. 3 shows a schematic diagram for the purpose of illustrating pulsed beams that were generated by a method according to a further specific embodiment of the present invention.

### DETAILED DESCRIPTION OF EXAMPLE EMBODIMENTS

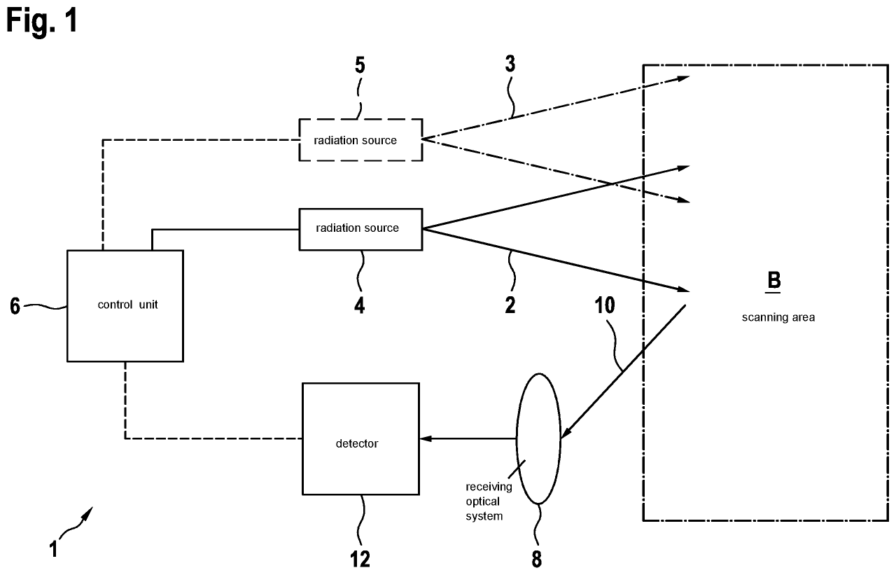

FIG. 1 shows a schematic illustration of a LIDAR device 1 according to the present invention according to one specific embodiment. LIDAR device 1 is used to scan a scanning area B using pulsed beams 2.

LIDAR device 1 includes a radiation source 4 according to the exemplary embodiment. Radiation source 4 is designed as an infrared laser that is operable in a pulsed manner.

Alternatively or in addition, further radiation sources 5 may be inserted into LIDAR device 1.

Radiation sources 4, 5 are connected to a control unit 6. Control unit 6 is configured to activate radiation sources 4, 5.

For example, control unit 6 may be designed as a driver or as an activation of radiation sources 4, 5. Control unit 6 may preferably activate the radiation sources at defined times and at a defined duration in such a way that radiation sources 4, 5 generate and emit pulsed beams 2.

Radiation sources 4, 5 may be situated in parallel next to one another, so that pulsed beams 2, 3 of particular radiation sources 4, 5 are slightly offset. Alternatively, a beam divider (not illustrated) or an optical coupling element may be used to configure pulsed beams 2, 3 to a defined exit location.

Furthermore, LIDAR device 1 includes a receiving optical system 8. Receiving optical system 8 may be designed as one or multiple lenses, lens systems, diffractive optical elements, filters, and the like. Together with radiation sources 4, 5 or in contrast to radiation sources 4, 5, receiving optical system 8 may be designed to be pivotable, rotatable, movable or immovable.

Receiving optical system 8 is used to receive beams 10 that are reflected and/or backscattered in scanning area B and to guide them onto a detector 12.

Detector 12 of LIDAR device 1 may preferably be an imaging detector. In particular, detector 12 may be designed as a CCD sensor or as a CMOS sensor.

Control unit 6 may also be connected to detector 12 in a data transferring manner. Alternatively, detector 12 may be read out by a separate control unit or evaluation unit and the corresponding measured data may be evaluated.

In this case, control unit 6 controls at least one radiation source 4, 5 in such a way that multiple pulsed beams 2 emulate a wider reference pulse in an amplitude-modulated manner.

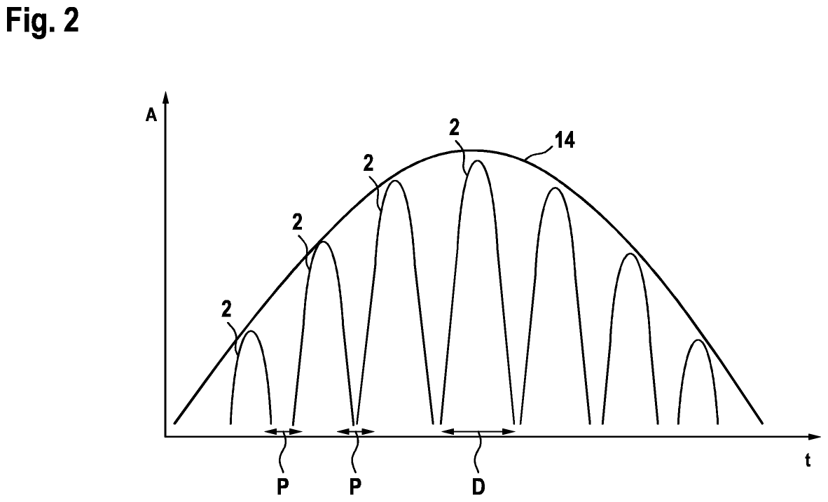

FIG. 2 shows a schematic diagram for the purpose of illustrating pulsed beams 2 to emulate a reference pulse 14, which were generated with the aid of a method according to one specific embodiment.

In the diagram, an amplitude A is plotted against time t. Reference pulse 14 is designed similarly to a Gaussian curve and represents a beam that is advantageous for an optimal exposure of detector 12.

As a result of the activation of radiation sources 4, 5 by control unit 6, it is possible to generate and emit multiple pulsed beams 2 temporally quickly one after the other. Amplitude A of pulsed beams 2 is adjusted by control unit 6 to an amplitude profile of reference pulse 14. Pulsed beams 2 thus have an increasingly ascending and subsequently once again descending amplitude A as a function of time t.

Pulsed beams 2 have a pulse width or pulse duration D. Pulse duration D is in this case shorter than a pulse duration of reference pulse 14. Furthermore, pulsed beams 2 are temporally spaced apart from one another by breaks P according to the illustrated exemplary embodiment. By extending breaks P between pulsed beams 2, the power density of the emitted radiation of LIDAR device 1 may be reduced and the risk of eye injury may be decreased.

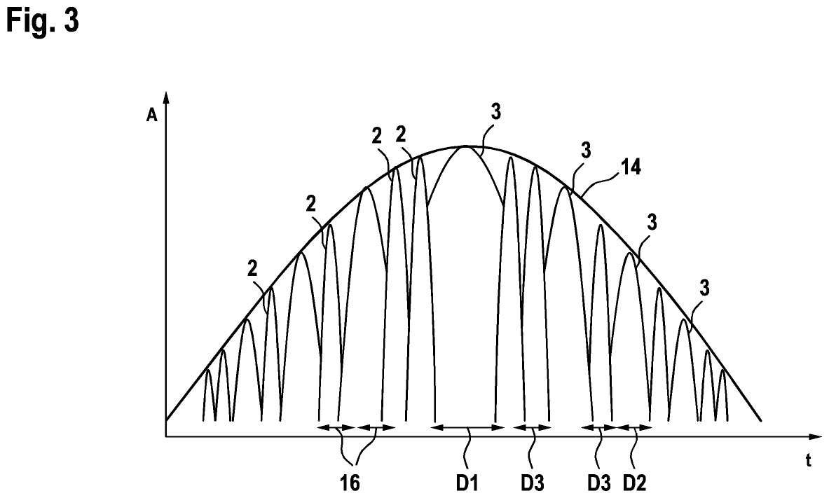

FIG. 3 shows a schematic diagram for the purpose of illustrating pulsed beams 2, 3 that were generated with the aid of a method according to a further specific embodiment. Pulsed beams 2, 3 were generated by two radiation sources 4, 5 that may be activated independently from one another. Pulsed beams 2 of a first radiation source 4 have a shorter pulse duration D3 than pulse duration D1, D2 of pulsed beams 3 of a second radiation source 5.

Pulsed beams 2, 3 are generated in such a way that they sectionally overlap. In particular, an overlap 16 results between temporally adjacent beams 2, 3. In this way, reference pulse 14 may be emulated more precisely.

Analogously to the diagram illustrated in FIG. 2, particular pulsed beams 2, 3 are designed in an amplitude-modulated manner, so that maximal amplitude A of particular pulsed beams 2, 3 follows or corresponds to the amplitude profile of reference pulse 14.

Pulsed beams 2, 3 have different pulse widths D1, D2, D3 that are set with the aid of a temporal modulation of control unit 6 when activating radiation sources 4, 5.

According to the exemplary embodiment, there are no pulse distances P between pulsed beams 2, 3.

1-14. (canceled)

15. A method for operating a LIDAR device using a control unit, the method comprising the following steps:
activating, by the control unit, at least one radiation source to generate pulsed beams, the pulsed beams being emitted into a scanning area; and
receiving beams that are reflected and/or backscattered in the scanning area, the beams being received by a receiving optical system and being guided onto a detector;
wherein an amplitude profile of a reference pulse is emulated by the pulsed beams of the at least one radiation source.

16. The method as recited in claim 15, wherein the pulsed beams are generated by the at least one radiation source in an amplitude-modulated manner.

17. The method as recited in claim 15, wherein an envelope curve modulation of the pulsed beams is carried out using the reference pulse as the envelope curve.

18. The method as recited in claim 15, wherein the pulsed beams are generated by the at least one radiation source to have the same pulse width.

19. The method as recited in claim 15, wherein the pulsed beams are generated by the at least one radiation source in a temporally modulated manner.

20. The method as recited in claim 15, wherein the pulsed beams are generated by the at least one radiation source in a sectionally overlapping manner.

21. The method as recited in claim 20, wherein an overlap of the pulsed beams is implemented by activating at least two radiation sources in an offset manner and/or by reactivating the at least one radiation source while generating a pulsed beam.

22. The method as recited in claim 15, wherein the pulsed beams are generated by the at least one radiation source at a variable temporal distance to one another.

23. The method as recited in claim 22, wherein the temporal distances for setting a signal-to-noise ratio are adaptively set.

24. The method as recited in claim 15, wherein the pulsed beams are generated by the at least one radiation source in a wavelength-modulated manner.

25. A control unit configured to operate a LIDAR device, the control unit configured to:
activate, at least one radiation source to generate pulsed beams, the pulsed beams being emitted into a scanning area; and
receive beams that are reflected and/or backscattered in the scanning area, the beams being received by a receiving optical system and being guided onto a detector;
wherein an amplitude profile of a reference pulse is emulated by the pulsed beams of the at least one radiation source.

26. A LIDAR device for scanning a scanning area using pulsed beams, comprising:
at least one radiation source operable by a control unit; and
a receiving optical system configured to receive and forwarding beams that are reflected and/or backscattered in the scanning area onto at least one detector;
wherein the at least one radiation source is operable by the control unit in such a way that multiple pulsed beams emulate a wider reference pulse in an amplitude-modulated manner.

27. A non-transitory machine-readable memory medium on which is stored a computer program for operating a LIDAR device using a control unit, the computer program, when executed by the control unit, causing the control unit to perform the following steps:
activating at least one radiation source to generate pulsed beams, the pulsed beams being emitted into a scanning area; and
receiving beams that are reflected and/or backscattered in the scanning area, the beams being received by a receiving optical system and being guided onto a detector;
wherein an amplitude profile of a reference pulse is emulated by the pulsed beams of the at least one radiation source.
